(19) United States
(12) Patent Application Publication
(10) Pub. No.: US 2018/0357440 A1
(43) Pub. Date: Dec. 13, 2018

(54) Personalized Meetings

(71) Applicant: Microsoft Technology Licensing, LLC, Redmond, WA (US)

(72) Inventors: Kyle Thomas BRADY, Seattle, WA (US); John C. GORDON, Newcastle, WA (US); Benjamin M. SCHULTZ, Bellevue, WA (US); Ali HAJY, Seattle, WA (US); Morakinyo Korede OLUGBADE, Seattle, WA (US); Hari R. PULAPAKA, Redmond, WA (US); Paul McAlpin BOZZAY, Redmond, WA (US); Frederick Justus SMITH, Redmond, WA (US); Mehmet IYIGUN, Kirkland, WA (US)

(73) Assignee: Microsoft Technology Licensing, LLC, Redmond, WA (US)

(21) Appl. No.: 15/621,692

(22) Filed: Jun. 13, 2017

(51) Int. Cl. G06F 21/62; G06Q 10/10

(52) U.S. Cl. CPC G06F 21/6218; H04L 63/101; G06Q 10/101

(57) ABSTRACT

Personalized containers for use at a public device are provided. A container can be personalized based on a multitude of factors including a profile associated with a user, a profile associated with the public device, a time of day, and a file accessed. The container can be used to access one or more sensitive files or programs associated with permissions. The permissions are consolidated and managed by the container such that only authorized users can view and edit the sensitive files or programs.

### BACKGROUND

The use of computing devices in public spaces is becoming increasingly common. While these public devices make sharing and accessing data easier, they are not without their problems. One such problem is that, due to their public nature, these devices lack the personalization and privacy people are accustomed to.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a user is authenticated at a host system. One or more preferences or permissions of the user are determined, from a profile associated with the user. A container, comprising an isolated computing space, is created based in part on the determined preferences or permissions, and provided for use at the host system.

In accordance with one or more aspects, multiple users are authenticated at a host system. A request is received to access sensitive data, the sensitive data associated with one or more permissions, and a determination is made if each of the multiple users is authorized to access the sensitive data based on the one or more permissions. A first set of sensitive data is displayed at a display device of the host system, each of the multiple users authorized to view the first set of sensitive data. A second set of sensitive data is not displayed at the display device of the host system, at least one of the multiple users not authorized to view the second set of sensitive data.

In accordance with one or more aspects, multiple users are authenticated, each of the multiple users associated with a different one of multiple user profiles. A container, comprising an isolated computing space containing one or more programs and files, is created, based in part on the user profiles. A determination is made that the one or more programs and files include sensitive data, the sensitive data associated with one or more permissions. A determination is also made if the multiple users are authorized to access the sensitive data, and a subset of the sensitive data is displayed at the computing device, the subset comprising the sensitive data that each of the multiple users is authorized to access.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example system for implementing personalized meetings in accordance with one or more embodiments.

FIG. 2 is a flowchart illustrating an example process for implementing personalized meetings in accordance with one or more embodiments.

FIG. 3 is a flowchart illustrating another example process for implementing personalized meetings in accordance with one or more embodiments.

FIG. 4 is a block diagram illustrating an example container for implementing personalized meetings in accordance with one or more embodiments.

FIG. 5 is a flowchart illustrating another example process for implementing personalized meetings in accordance with one or more embodiments.

FIG. 6 is a flowchart illustrating another example process for implementing personalized meetings in accordance with one or more embodiments.

FIG. 7 is a flowchart illustrating another example process for implementing personalized meetings in accordance with one or more embodiments.

FIG. 8 illustrates an example system that includes an example computing device that is representative of one or more systems and/or devices that may implement the various techniques described herein.

### DETAILED DESCRIPTION

Personalized meetings are discussed herein. These personalized meetings start with a user being recognized at a host system. Recognizing a user may comprise facial recognition, entry of a username and password, biometric scanning, or any other means. A container is used at the host system as a private computing space for use by the user. The container can be a standard container or can be customized based on a number of factors including characteristics of the user, the host system, the time of day, the first programs or files accessed by the user, combinations thereof, and so on. A container can be customized by building a new container on the fly or can be customized by adding layers to a standard base container, or otherwise customizing a standard container.

A learning system can be employed either at the host system or within a network such that the containers that are provided to a user are updated over time. For instance, if at a particular host device, a particular application that is not originally included in a container is consistently installed during usage sessions, the learning system can cause the application to be included in the containers for the host system. Additionally, the learning system can learn preferences of individual users. These preferences can be stored in association with an established profile of the user or can be stored at the host system. Further, preferences for groups of users can be learned. These groups can be, for example, users who belong to a same department or team, or groups of users concurrently using a host system.

Additionally, during the usage session, a user may wish to access sensitive data. The sensitive data may be associated with one or more permissions, such as an Access Control List (ACL), that details which users are allowed access, and at what level, to the sensitive data. For particular users this can include read/write permissions for some or all of the sensitive data, this may include permission to share the sensitive data with other users, and so forth. When a file, program, or application with associated permissions or otherwise tagged is opened, referred to herein as “sensitive data”, the permissions can be copied and stored into the container. Consolidating and storing the permissions allows the container to determine whether all present users are allowed to view the sensitive data. If so, the sensitive data is displayed at the host system. If not, the sensitive data can be displayed on a second device, such as a head mounted display of a user, that can only be viewed by users who are authorized to view the sensitive data.

While the techniques discussed herein are described in terms of containers and layers, other implementations of personalization of usage sessions on public devices can use these techniques. For instance, one or more of the following described techniques can be performed by a user interface of an operating system (a shell), such as a graphical user interface.

The techniques discussed herein provide both security and ease when using a public computing device for a meeting. Containers can be customized to or selected based on the meeting user(s), providing a custom feel to the user for the meeting regardless of what computing device is being used for the meeting. Furthermore, meeting views can be changed based on the users that are present in the meeting, allowing sensitive data to remain private and not displayed to those that are not permitted to view the data.

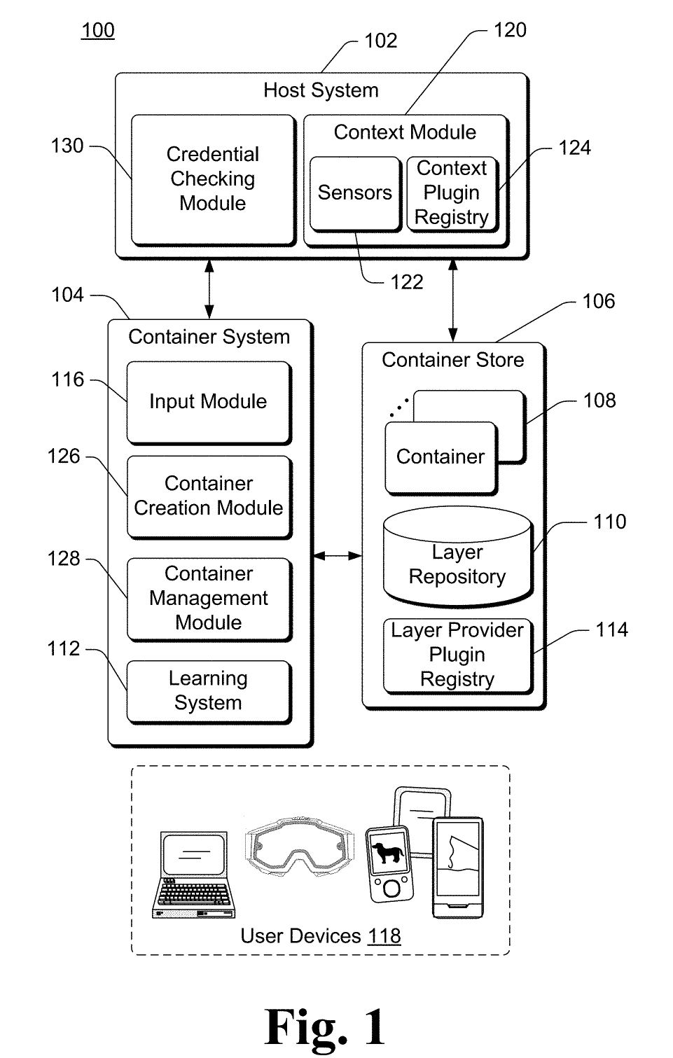

FIG. 1 illustrates an example system 100 implementing personalizing meetings in accordance with one or more embodiments. System 100 is implemented at least in part by one or more computing devices. Any of a variety of different types of computing devices can be used to implement the system 100, such as a server computer, a desktop computer, a laptop or netbook computer, a virtual meeting hosting device, a mobile device (e.g., a tablet or phablet device, a cellular or other wireless phone (e.g., a smartphone), a notepad computer, a mobile station), a wearable device (e.g., watch, bracelet, head mounted display (such as eyeglasses, virtual reality (VR) glasses or headset, augmented reality (AR) headset or glasses)), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the computing device implementing system 100 may range from a full resource device with substantial memory and processor resources (e.g., personal computers, game consoles) to a low-resource device with limited memory and/or processing resources (e.g., traditional set-top boxes, hand-held game consoles).

The system 100 includes a host system 102 and a container system 104. In one or more embodiments, the host system 102 and the container system 104 are implemented as part of the same computing device. Alternately, at least part of the container system 104 can be implemented on a separate device from the device implementing the host system 102. In a network implementation comprising multiple host systems 102, each host system 102 can have an individual container system 104, or the multiple host systems 102 can share one or more container systems 104.

Additionally, a container store 106 for storing containers 108 after they have been created by the container system 104 can be implemented on the same or a different device from that on which the container system 104 and host system 102 are implemented. For instance, the container store 106 can be implemented as part of the container system 104, as part of the host system 102, or as part of a cloud accessible by multiple container systems 104 and multiple host systems 102. The container store 106 can optionally be multiple container stores 106. For example, if the container system 104 is implemented in a network that comprises multiple host systems 102, a container store 106 for each host system 102 could be implemented such that the host system 102 only has access to the container store 106 associated with the host system 102. Alternatively, the container store 106 could be implemented via a cloud as a service accessible to all host systems 102 connected to the network. The container store 106 can store unused containers as well as saving containers associated with users such that a same container can be used during multiple usage sessions.

Each container is an isolated computing space provisioned with various data for a usage session. Multiple containers can be run at the host system 102 concurrently, with each container including one or more components. These components include, for example, virtual devices (e.g., one or more processors, memory, storage devices), a base operating system (e.g., an operating system kernel), a user-mode environment, applications, and so forth. A base operating system component provides various different low level system services to components in the container, such as session management, program execution, input/output services, resource allocation, and so forth. The base operating system component can be a full operating system, or alternatively only a portion of a full operating system (e.g., the base operating system component may be a very small component if the container shares most of the operating system with the host (in particular, the kernel)). The user-mode environment component provides a runtime environment for applications in the container (e.g., a Java Runtime Environment, a .NET framework, and so forth). The application component is an application that is desired (e.g., by a user, administrator, other program, etc.) to be run in the container (e.g., a web service, a calculation engine, etc.).

One type of container that a container 108 can be implemented as is referred to as a process container. For a process container, the application processes within the container run as if they were operating on their own individual system (e.g., computing device), which is accomplished using namespace isolation. The host system 102 implements namespace isolation. Namespace isolation provides processes in a container a composed view consisting of the shared parts of the host operating system and the isolated parts of the operating system that are specific to each container such as file system, configuration, network, and so forth.

Another type of container that a container 108 can be implemented as is referred to as a virtualized container. For a virtualized container, the virtualized container is run in a lightweight virtual machine that, rather than having specific host physical memory assigned to the virtual machine, has virtual address backed memory pages. Thus, the memory pages assigned to the virtual machine can be swapped out to a page file. The use of a lightweight virtual machine provides additional security and isolation between processes running in a container. Thus, whereas process containers use process isolation or silo-based process isolation to achieve their containment, virtualized containers use virtual machine based protection to achieve a higher level of isolation beyond what a normal process boundary can provide. A container may also be run in a virtual machine using physical memory of the host system 102, and cloning can be used to copy the state of the template container into the physical memory used by the new container. Such a container using physical memory allows for higher isolation, e.g., in situations where the use of virtual memory for the virtual machine is not desired because of performance or security concerns.

The container store 106 can optionally include a layer repository 110. Alternately, the layer repository 110 can be implemented separately, or not included. The use of layers can reduce the computational load for creating a container by eliminating computing redundancy resulting in a container being provided more quickly to a user. The layer repository 110 can contain various types of layers such as base layers, user specific layers, host specific layers, and so on. A base layer may comprise the components to instantiate a container as well as any desired applications, programs, or files. The desired applications, programs, and files can be determined based on a learning system 112. Additional layers can be added to the base layer to personalize the container for the user or users, host device, time of day, type of applications, and so on.

The layer repository 110 can be a static repository or can communicate with the container system 104 to add newly created layers to the layer repository 110. The layer repository 110 can be implemented at any level, for instance, a single layer repository 110 can be accessible across an enterprise or a layer repository 110 can be implemented for each container system 104 or host system 102. Alternately, the layer repository 110 could be a service accessible to multiple enterprises. As such, keeping data layers that contain user specific information private is important. Accordingly, user specific layers can be associated with a credential such that they are only accessible when the user is present, can be stored separately from widely available layers, or can be created on the fly rather than stored. Layers can additionally be tagged as sensitive and thus require certain conditions (e.g., a specific user or group of users, a specific device) to be opened.

Additionally, the container store 106 may include a layer provider plugin registry 114. The layer provider plugin registry 114 can register layer providers and implement an Application Programming Interface (API) and/or an Application Binary Interface (ABI). The layer provider plugin registry 114 can facilitate layer provisioning in order to surface layers that best meet the need. Additional discussion of the layer provider plugin registry 114 can be found below.

The container system 104 includes an input module 116. The input module 116 receives inputs from a variety of sources including user inputs provided by a user, and inputs received over a network from other devices. User inputs can be given at the computing device on which the container system 104 is implemented, or on an external computing device. These inputs can be provided by a user pressing one or more keys of variety of different manners, such as by pressing one or more keys of a keypad or keyboard of the computing device, pressing one or more keys of a controller (e.g., remote control device, mouse, track pad, etc.) of the computing device, pressing a particular portion of a touchpad or touchscreen of the computing device, making a particular gesture on a touchpad or touchscreen of the computing device, and/or making a particular gesture on a controller (e.g., remote control device, mouse, trackpad, etc.) of the computing device. User inputs can also be provided via other physical feedback input to the computing device, such as tapping any portion of the computing device, an action that can be recognized by a motion detection or other component of the computing device (such as shaking the computing device, rotating the computing device, bending or flexing the computing device, etc.), and so forth. User inputs can also be provided in other manners, such as via voice or other audible inputs to a microphone, via motions of hands or other body parts observed by an image capture device, and so forth. User inputs can be provisioned to the input module 116 directly or indirectly.

Additionally, the input module 116 can receive inputs from additional devices over a network or other wired or wireless connection. These additional devices can include one or more user devices 118. User devices 118 can take the form of any computing device including a wearable device such as a head mounted display for presenting an augmented reality (AR) environment, or a personal device such as a tablet, smartphone, or laptop. A user device 118 can be used to augment the functionality of the host system 102. A user device 118 can also authenticate a user, for instance by using NFC to provide user credentials. Additionally, a user device 118 can be used to provide inputs prior to creation of a container or to affect the container in use.

One of the additional devices from which the input module 116 can receive input is the host system 102. The host system 102 may comprise a context module 120 for consolidating and providing context about a usage scenario to the container system 104. The context module 120 may include one or more sensors 122 that determine environmental factors related to a room in which the host system 102 is to be used. These sensors 122 can include a camera which can determine characteristics of the room including the size, color, motifs, available light, number of users, etc., and can be used to identify users. The sensors 122 can further include one or more Global Positioning System (GPS), Bluetooth, magnetic orientation sensor, ambient light sensor, gyroscope, accelerometer, inertial measurement unit (IMU) and so on. Further, the host system 102 can provide inputs to indicate resources available such as Bluetooth, speakers, disc drives, ports, and other capabilities available for use at the host system 102 such that a container 108 can include appropriate infrastructure to support these capabilities.

The context module 120 may further comprise a context plugin registry 124. The context plugin registry 124 allows users and application developers to add domain-specific markup to the contextual data determined by the context module 120. The context module 120 can facilitate delivery of third party context extraction through extension points in an API or an ABI. The API for the context module 120 includes at least one method to extract content. The method returns a binary blob or a fragment of human readable code such as using Extensible Markup Language (XML) or JavaScript Object Notation (JSON). The context plugin registry 124 may cycle through the context providers in order to provide the input module 116 contextual data not accessible by the host system 102 alone. For instance, a context provider provided by a video conferencing application developer may be able to extract the users in a video conference meeting run by a video conferencing application and provide the user data as user items to the context module. Alternately, a television programming provider may deliver a context provider that identifies television shows playing on selected channels.

The context module 120 may cause contextual data to be collected, and also compiles the contextual data in order to communicate it to the container system 104. The contextual data can include data from the sensors 122, a number of connected or nearby devices, a type of connected or nearby devices, a time of day, a location of the host system, identification of one or more users, a calendar or schedule associated with the one or more users or with the host system 102, one or more files or applications accessed, settings at the host system 102, or any data deemed relevant to selecting an appropriate container. The contextual data may be gathered from multiple context providers registered with the host system 102. Compiling the contextual data may comprise controlling the format or reformatting information provided by the context providers in order to compile the contextual data. Additionally, compiling the contextual data may comprise aggregating the contextual data into a collection of data that specifies characteristics of the meeting, or characteristics of the desired container.

Further still, the host system 102 may provide information relating to the topography of host devices in an environment. For example, if multiple host systems 102 exist in a room, the host systems 102 may know their relative locations such that a set of multi-system containers can be created in order to utilize the multiple host systems 102. A set of multi-system containers can include a continuous background image that continues from one container to another container creating a cohesive environment while maintaining isolated containers for each of the multiple host systems. Alternately, topological information can be maintained or accessible to the container system 104 from another source.

The container system 104 also includes a container creation module 126. Alternately, the container creation module 126 can be implemented at the container store 106, or can be implemented separately. The container creation module 126 creates containers 108 for use by the host system 102. The container creation module 126 receives the compiled contextual data sent by the context module 120 via the input module 116 and creates the container 108 based on the contextual data. The container can be built to include information received by the input module 116, or data derived from the information received by the input module 116, including data from a user or group profile, a profile related to the host system 102, and data obtained by the sensors 122. For example, the container creation module 126 can create a container 108 for a meeting when a user or group of users is recognized at the host system 102, can create standard containers and customize those containers by adding layers, and so on.

Alternately, the container creation module 126 can determine contextual data to pass to the container store 106 to provide an appropriate container. For instance, the container creation module 126 may simply receive an identifier of the container or project and pass the identifier to the container store 106 to request the container 108. The identifier can be associated with a scheduled meeting, with a user, can be entered manually by the user at the host system 102, or received in any other desired manner.

Alternately, the container creation module 126 can restructure the contextual data to send to the container store 106 to determine what the container is to include. Alternately, the input module 116 may receive contextual data not compiled by the context module 120, and the container creation module 126 may compile the contextual data.

The compiled contextual data can be sent to the container store 106, where the container store 106 can determine if a pre-built container matches the contextual data. A pre-built container is determined to match contextual data if the metadata associated with the pre-built container indicates it is compatible with the contextual data. For example, if the contextual data indicates that a large number of users has approached the host system 102 (for example, more than five users), a container may be determined to match the contextual data if the container is tagged as being for large groups. A container that matches the contextual data indicating a large group might alternately possess certain characteristics, such as a large display and font size, applications geared toward sharing information, and so on. Matching the contextual data to containers may further employ a learning system such that the matching of contextual data to containers evolves with use. If multiple containers match the contextual data, the multiple containers can be ranked based on the contextual data to determine a best fit container, and the best fit container can be provided to the host system 102. Alternately, a list of the multiple containers can be presented at the host system 102 for selection by the user.

Additionally, the container store 106 can use the contextual data to modify a pre-built container or create a new container. Similarly, to the discussion above regarding matching contextual data to a container, modifying the pre-built container may comprise comparing metadata associated with one or more layers in the layer repository 110 to determine if the layers are to be included in the container 108. Alternately, or additionally, the container store 106 can pass the contextual data on to one or more layer providers via the layer provider plugin registry 114. The layer providers can compare the contextual information and determine whether a layer exists that matches some or all of the contextual data, or if a layer can be created to match the contextual data. It is considered that the layer provider plugin registry 114, could also query the layer repository 110. The one or more layers in the layer repository 110, and/or determined from the layer provider plugin registry 114, may be used to create a container to suit the contextual data, for example, by iterating through layers in the layer repository 110 to select layers that match the contextual data.

The container system 104 further includes a container management module 128. The container management module 128 can associate a container with a project or user, and allows a container 108 to be used over multiple usage sessions. The container management module 128 can determine, based on user authentication, what a particular user has permission to access (e.g., which files, projects, containers, and/or layers) and can retrieve the container and appropriate layers and provision them to the host system 102. The container management module 128 can also create containers and layers as needed.

Additionally, the container management module 128 can manage associations beyond what occurs in the containers, such as associating a project with one or more emails, instant messaging (IM) chats, and so on. In this way, a user can request an overview of data in order to view how the project developed over time. The container management module 128 can track these associations in various manners. For example, a record of the associations for a container 108 may be included in the container (e.g., encrypted for or otherwise accessible only to the container management module 128), in a record maintained by or otherwise accessible to the container management module 128, and so forth.

The container system 104 employs the learning system 112 to learn usage trends for users and host systems 102, as well as other usage trends. The container system 104 can learn settings specific to a host system 102, specific to a user or group of users, applications, or data types. If users of a particular host system 102 frequently adjust settings in the same way, the container system 104 can associate these settings with the host system 102. A setting can be if 70% of users adjust the font size on a display to be bigger, the default font size for the host system 102 can be increased. It should be noted that other percentages can be used and that threshold percentages can vary between settings. Similarly, if a particular user makes a same change, metadata can be added to the user's profile. Alternately, this learning system could store the learned data at the container system 104.

The host system 102 may further include a credential checking module 130 which validates the credentials for each user. This may comprise detecting a credential, such as a username and password, recognizing a user using biometric scanning or facial recognition, and so forth.

Further still, the credential checking module 130 can obtain authorization information such as user permissions from user profiles and required permissions from files or programs in order to ensure that present users are authorized to access the data displayed at the host system 102. Obtaining the authorization information may comprise querying one or more of files, programs, user profiles, and so on for ACLs. The ACLs are stored by the container such that the enforcement of the ACLs is done at the host system 102. Alternately, the ACLs can be enforced at the file level.

A user profile can be a profile associated with a user and can be maintained in a database accessible to the credential checking module 130. In addition to containing permissions associated with a user, a user profile can optionally include one or more preferences or characteristics of the user, a layer associated with the user, or any other information relevant to the user. For instance, the user profile can indicate that a user prefers a specific font size, or belongs to a particular group. Alternately, the credential checking module 130 can receive the permissions associated with the users, files, programs, and so on when the container is received from the container system 104.

The credential checking module 130 can use the permissions to enforce access to sensitive data associated with permissions. Enforcing access comprises determining what information is to be displayed at the host system 102, and what data cannot be displayed at the host system 102 based on the permissions. Permissions can be tracked for activities (such as running programs, accessing webpages, downloading files, and so on), files (who can access, write, and share), data points within a file, and so on. Enforcing access may also comprise determining that one or more files or data points can be accessed by some users and cannot be accessed by others. This may comprise sending the sensitive files or data points to a user device 118 to be displayed.

Enforcing access may additionally comprise, responsive to additional users being detected, causing one or more pieces of data to be removed from the display and optionally sent to one or more user devices 118 associated with users who have permission to view the sensitive data. For example, if a group of users, each belonging to a “managers' group” is accessing a PowerPoint showing sensitive data such as confidential employee data, the confidential employee data can be removed from the display responsive to detecting a new person. Removing the sensitive data may comprise removing or obscuring the PowerPoint application from the display. Optionally, the confidential employee data can be transferred to and displayed at each of the managers' personal devices. Alternately, removing the confidential data may comprise removing or obscuring the data itself In this scenario, the sensitive data is associated with an ACL. It is considered that a file may contain both sensitive data and unsecured data. For instance, the managers' PowerPoint may contain headings that are unsecured, and confidential employee data that is sensitive. When the new person is detected, the confidential employee data can be obscured or removed and sent to (and displayed at) the managers' devices while the headings remain displayed at the host system 102. If a manager's device is a head mounted display, the confidential employee data may be displayed such that it appears to the manager to be displayed on the host system 102.

When data is displayed on a head mounted display, it may be displayed in such a way that sets it apart from data that is actually displayed at the host system 102. For instance, the sensitive data may be highlighted, presented in a different color or font, or otherwise marked to notify the authorized users to avoid verbal disclosure. This allows a scenario in which, for example, a subset of the managers may be able to see all the data points about the employee via head mounted displays, while the rest of the managers may be shown a limited subset of the employee information via the host system 102. The head mounted displays may visually fill in information for the users who are authorized to see the data. Some user devices 118 may implement eye tracking and notify the user when their eyes focus on sensitive data. Alternately, the host system 102 may track the user's gaze and alert the user that they have focused on sensitive data being displayed either at the user device 118 or at the host system 102. The notification may be verbal, tactile, visual, and so on.

Enforcing access may further include accessing additional data responsive to a new user being detected, or redistributing how the data is displayed based on a change in detected users. For instance, continuing the scenario of the managers' meeting, the new person can be authenticated and be determined to be authorized to view the confidential employee data. Responsive to determining the new person is authorized to view the data, the data can be unobscured or redisplayed at the host system 102. Alternately, the user may be determined to be authorized to view a subset of the confidential employee data, in which case, only that data which the user is authorized to view is unobscured or redisplayed.

Further still, enforcing access may comprise removing from the display one or more pieces of data associated with a user when the user leaves. For example, if each of the managers in the managers' group is authorized to share a subset of confidential employee data with other managers (e.g., the employee data of employees the manager is responsible for), and a manager leaves, the confidential employee data associated with the manager that left can be removed from the display. Alternately, if a user is associated with a data layer, the data layer can be saved and removed from the container when it is detected that the user has left.

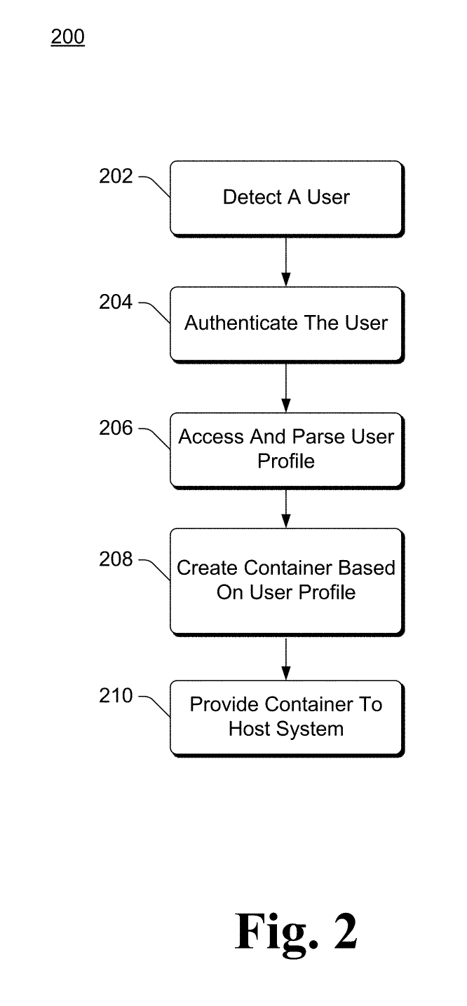

FIG. 2 is a flowchart illustrating an example process 200 for personalizing meetings in accordance with one or more embodiments. Process 200 is an example process and can alternately comprise fewer or additional elements.

In act 202 a user is detected. Detecting a user can comprise motion detection or video or image recognition that a person is in a vicinity of the host system, such as entering a room in which the host system is located, coming within a threshold distance (e.g. 15 feet) of the host system, or approaching the host system (e.g. walking toward the host system rather than laterally along the host system). Alternately, detecting a user can comprise receiving user credentials such as a username and password, biometric screening, near-field communication (NFC) with a device associated with a user, scanning a key or ID card, and so on.

In act 204, the user is authenticated. The user can be authenticated based on information used during the detecting of act 202. Alternately, additional user credentials can be required to authenticate the user. Authenticating a user may comprise locating a user profile associated with the user, or recognizing that the user is not associated with a profile. If the user is not associated with a profile, one may be created for the user.

In act 206, the user profile of the user is accessed and parsed. The information stored in the user profile can be parsed to determine preferred settings for display, commonly used applications and preferred settings within applications, browser favorites, desktop organization, and so on. These preferences and settings can be related to the layout and applications included in the container, can be accessibility settings, display sizes, or any other settings either global to the container or specific to an application. Parsing the data in the user profile can additionally comprise determining permissions associated with the user. These permissions can be copied from the user profile and stored to the credential checking module 130 of the host system. Alternately, the user credentials can be stored by the container so the user does not have to repeatedly enter credentials during a usage session.

In act 208, a container is created based on the parsed information from the user profile. Creating the container can refer to building a container from scratch on the fly, determining one or more preexisting layers to comprise the container, making adjustments to a standard container, or simply providing a standard container without adjustments. Alternately, a pre-built container associated with the user profile can be pulled from the container store 106. Additionally, creating the container can comprise accessing one or more pieces of sensitive data based on the user credentials.

In act 210, the container is provided to the host system. Providing the container to the host system 102 may include causing the container to be opened at the host system 102.

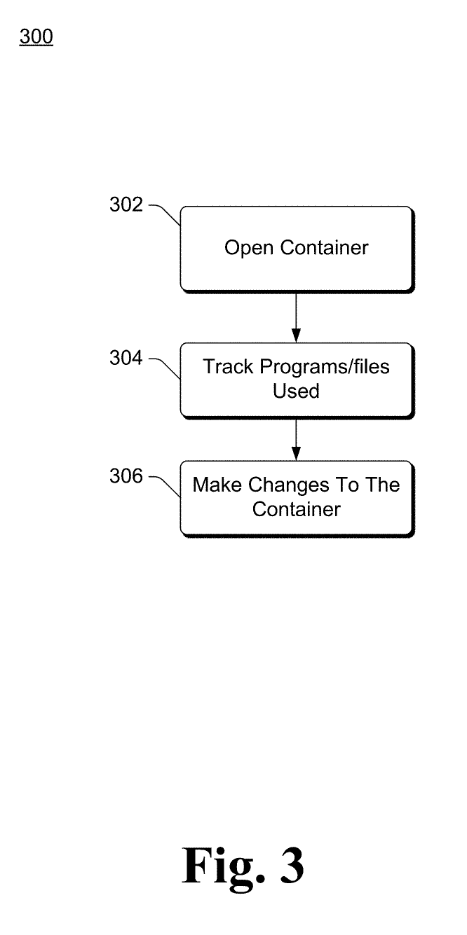

FIG. 3 is a flowchart illustrating an example process 300 for personalizing meetings in accordance with one or more embodiments. Process 300 is an example process and can alternately comprise fewer or additional elements.

In act 302, a container is opened. The container can be opened automatically after the container is created and received at the host system 102. Alternately, the container can be opened responsive to a command received at the host system 102.

In act 304, user interaction with the container is tracked. The interactions can be stored such that the learning system 112 can cause a better container to be provided to the user. For example, it may be noted that a user consistently opens a web browser as a first action in a container (e.g., 70% of the time the user uses a container, their first action is opening a web browser). User interactions may be tracked throughout a user's interaction with a container such that user interactions can be selectively saved to a user specific layer, or otherwise associated with the user or the user's profile.

In act 306, changes are made to the container based on the data accessed by the user. This can comprise adding or removing one or more layers, programs, or files for a more streamlined experience for the user. For instance, if a user navigates to a file associated with a program that was not included in the container, an additional layer including the program can be added to the container. Alternately, if a user access a certain program, the learning system 112 may determine that the user is likely or unlikely to access other programs and can either load or remove those other programs from the container in order to provide a streamline experience to the user. Alternately, changes to the container may comprise hot swapping the containers such that the original container can be replaced with a different pre-built container that better suits the user's needs. These changes may be time limited, or limited in some other way to avoid making intrusive changes. For instance, hot swapping the container may only be an option until the first file or program is accessed, or for the first minute of use. Adding or removing layers may be limited to the first 3 files or programs, or the first 5 minutes.

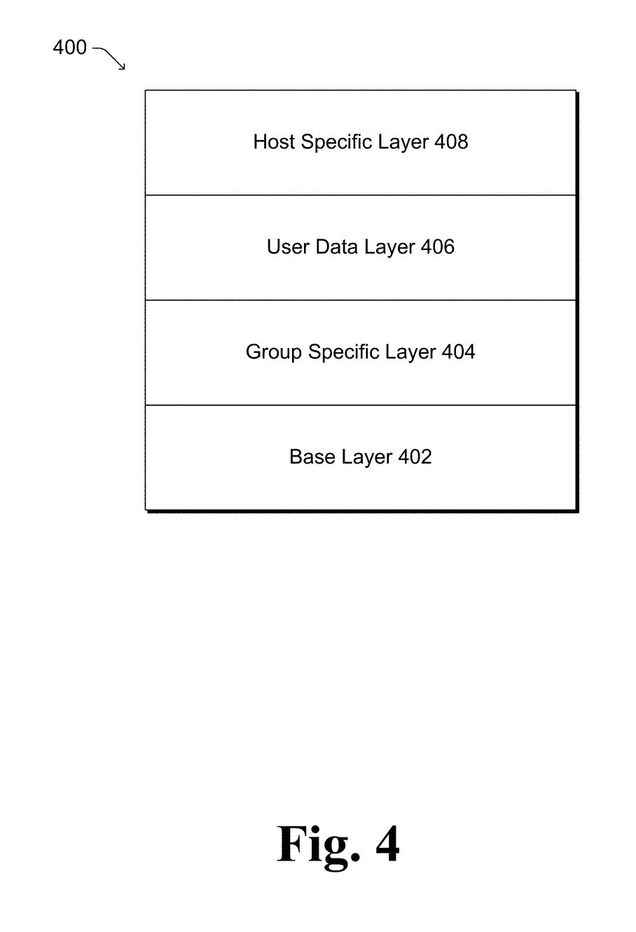

FIG. 4 is an example of a container 400 in accordance with one or more embodiments. The pictured layers are a single example of layers that can be included in a container and could be combined into fewer layers, broken out into additional layers, or different layers can be included. Layers can be stored in the layer repository 110 which can be a part of the container store 106 or can be implemented separately. Layers can be used in order to maintain data in a way that is easy to access by its owner or owners while also maintaining privacy from other users. Further, layers provide additional flexibility

Layers can be added or removed from a container at any time, including during the use of a container. For instance, if a container is created for an original meeting, the layers can be updated to reflect changes made during the meeting. Additionally, a layer can be added or removed when a user enters or leaves a meeting.

Layers can be created or selected from a layer repository 110. A base layer 402 can include applications and data accessible to every person with access to the container. Applications can be determined based on files accessed during the usage session, based on the users or combination of users accessing the container, based on the host system, and so on. The user settings that are included in the container can be any combination of user settings from the associated users. For example, any accessibility settings required by any single user can be included in the container. The user settings can apply globally to the container or be specific to applications loaded in the container.

A group specific layer 404 can be included. The group specific layer 404 can include information that is restricted to users who can be authenticated to be part of a set of users identified as a group, or can be applied when certain user access a container together. A group defined as any desired set of users given permission to access a group specific layer 404. The group specific layer 404 can include applications, files, settings, and so on that are not included in the base layer 402.

A user data layer 406 can optionally be one or more layers for each user or a single layer that combines user data for the users. User data can be applications, application settings, accessibility settings, stored credentials, references to information locations and so on. A user data layer 406 can be stored in the layer repository 110, stored as part of a user profile, or created specifically for a container 108. A user data layer 406 can be the intersect of user data when multiple users are accessing a container together. Alternately, user data can be sent to the user device 118.

A host specific layer 408 can be applied by the container system 1 or by the host system 102 and can include a theme, background image, display settings, and so on. The host system 102 can implement a standalone learning system and store and add the host specific layer 408 upon receiving the container 108. Alternately, the learning system 112 can track settings and preferences associated with the host system 102 and include the host specific layer 408 in the container 108. The host specific layer 408 can additionally include display themes, settings, applications, files, and so on associated with a specific host system 102. This can include provisions for external devices not available at all host systems 102 such as Bluetooth, speakers, headsets, and so on.

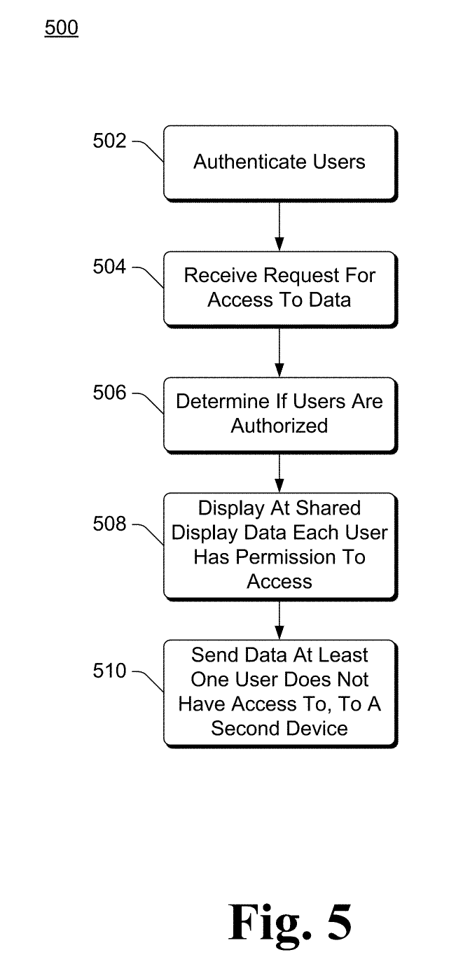

FIG. 5 is a flowchart illustrating an example process 500 for personalizing meetings in accordance with one or more embodiments. Process 500 is an example process and can alternately comprise fewer or additional elements.

In act 502, users are authenticated. Authenticating the users can comprise facial recognition, biometric scanning, username and password, or any other means of authentication. It may be required that all present users are authenticated in order to proceed. Alternately, a single user or some subset of users are required to be authenticated.

In act 504, a request for access to data is received. The request can be received at the host system 102 and communicated to the container store 106. The request to access data can comprise a request for a container 108 or layer. Alternately, the request to access data may comprise a request for a particular file or program, or a request to perform an action such as downloading or installing a program or file.

In act 506, it is determined if users are authorized. This can be determined based on information stored in the user profile of each user, stored with the data, or some combination thereof. Data is determined to be sensitive data if there are permissions that limit user access to the data. The permissions for different pieces of sensitive data can vary among users such that some users have read/write access while others have only read access, and some users may not have access at all. Additionally, some users may be authorized to share data, either with any user or with a particular subset of users such as users belonging to a particular group or having a particular permission or characteristic. Determining if a user is authorized may comprise determining if the user has an appropriate level of access for the request.

Additionally, determining if users are authorized may include obtaining authorization information and credentials associated with the users and storing this information in the container such that the host system 102 can authorize the users to access files, programs, and so on based on their presence and user profile.

In act 508, the data that each of the users has permission to view is displayed at the display device of the host system. The subset of data displayed at the display device is the intersect of data that the users have permission to view. Additionally, if a single user is authorized to share data with other users, that sensitive data can be displayed at the display device. Alternately, if one or more users are not authorized to view data, the application to display the data may be displayed on the display device, while the data is not displayed on the display device. Further, some parts of the data may be displayed, for instance titles, headers, etc., while other parts of the data are not displayed on the display device. The permissions may be tracked at a file level and at specific data points, and may also be associated with performable actions.

In act 510, sensitive data that at least one user does not have access to is sent to a second device. The second device can be one or more user devices 118. The sensitive data could be a single user's notes, could be a high security file, or any other data with restricted access. The user device 118 could be a head mounted display such that the sensitive data appears to the user to be displayed on the display device, but is not displayed for unauthorized users. Alternately, the user device 118 can be any device associated with a user at which a user can expect a base level of security such as a laptop, tablet, or mobile phone.

An example scenario following process 500 follows. A group of users are authenticated as they approach a host system, each user authenticated as being an employee of an enterprise. The users' approach is interpreted as a request for a container. A container matching the group is procured at the host system 102. Further discussion of finding a matching container can be found in reference to FIG. 1. The user profiles for each of the users are accessed and permissions associated with the users are loaded into the container. Thus, when a user requests a file associated with permissions, for example, a file that only members of a certain team can access, it can be determined at the host system 102 if the user is authorized to access the file. For instance, if the user requests a meeting minutes document, it can be determined that all the present users are authorized to view the document and the document is displayed at the display device.

In another example, if the user requests a design plan and it is determined that one or more of the present users are not authorized to view the design plan, an indication can be displayed on the display device such as opening an application in which the design plan could be viewed, but not displaying the design plan, or a message could be presented indicating that one or more users are not authorized. If both the meeting minutes document and the design plan are requested, the meeting minutes and the indication regarding the design plan are displayed at the display device, but the design plan itself is not displayed. If the user who requested the design plan is authorized to view the design plan and is associated with an additional device, the design plan can be sent to and displayed at the additional device. Additionally, additional devices of other present users who are also authorized to view the design plan can be sent and display the design plan. If the user's additional device is a head mounted display, the design plan can be displayed in the head mounted display to appear as part of the display device visible to all users, while only appearing to the user.

Alternately, when the user requests the design plan, one or more parts of the design plan may be sensitive while other parts are not sensitive. While the user who requested the design plan may be authorized to access the entire design plan, in a setting where at least one user is not authorized to view the entire plan, the parts of the design plan that are not sensitive may be displayed at the shared display device, such as an overview or outline of the design plan that conceals or does not display sensitive information. Sensitive parts of the design plan may not be displayed by the host system 102, but may instead be displayed by the authorized user's user device 118. The parts displayed at the user device 118 may be marked in some way so as to notify the authorized user that they are sensitive and should not be disclosed. For instance, the sensitive data may be highlighted, displayed in a different color or font, associated with a symbol, or marked in any other manner.

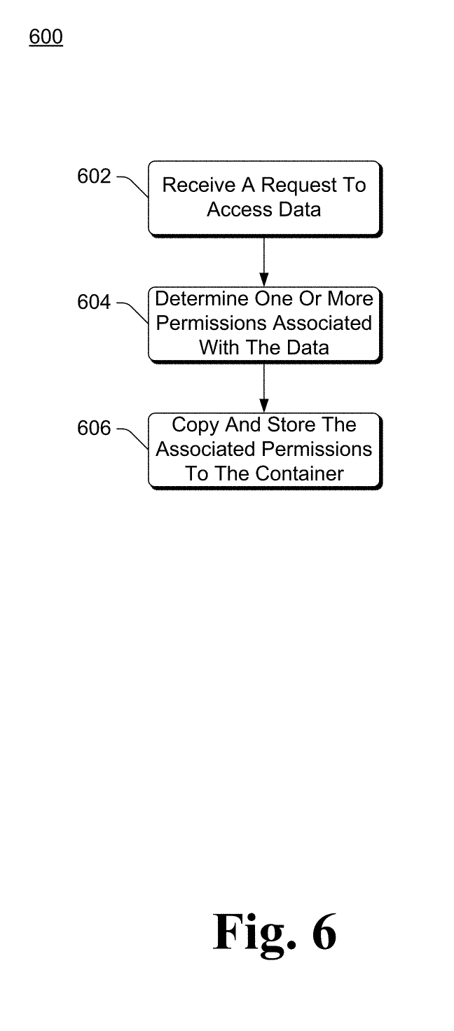

FIG. 6 is a flowchart illustrating an example process 600 for personalizing meetings in accordance with one or more embodiments. Process 600 is an example process and can alternately comprise fewer or additional elements.

In act 602, a request to access data is received. The request can be received at the host system 102 and communicated to the container store 106. The request to access data can comprise a request for a container 108 or layer. Alternately, the request to access data may comprise a request for a particular file or program, or a request to perform an action such as downloading or installing a program or file.

In act 604, one or more permissions associated with the data are determined. The one or more permissions may be determined as part of creating or providing a container or layer. Alternately, the permissions may be determined when a file, program, or other piece of data is accessed. The one or more permissions may take the form of an access control list which can specify one or more users or groups of users who have permission to access the data. The one or more permissions may further require that the data be accessed at particular host systems, and may dictate read/write permissions.

In act 606, the permissions are stored to the container. From the container, the consolidated credentials for the container can be accessed by the credential checking module 130 of the host system 102. The credential checking module 130 enforces the permissions at the host system 102 by ensuring that each user of the host system 102 is authorized to view the sensitive data.

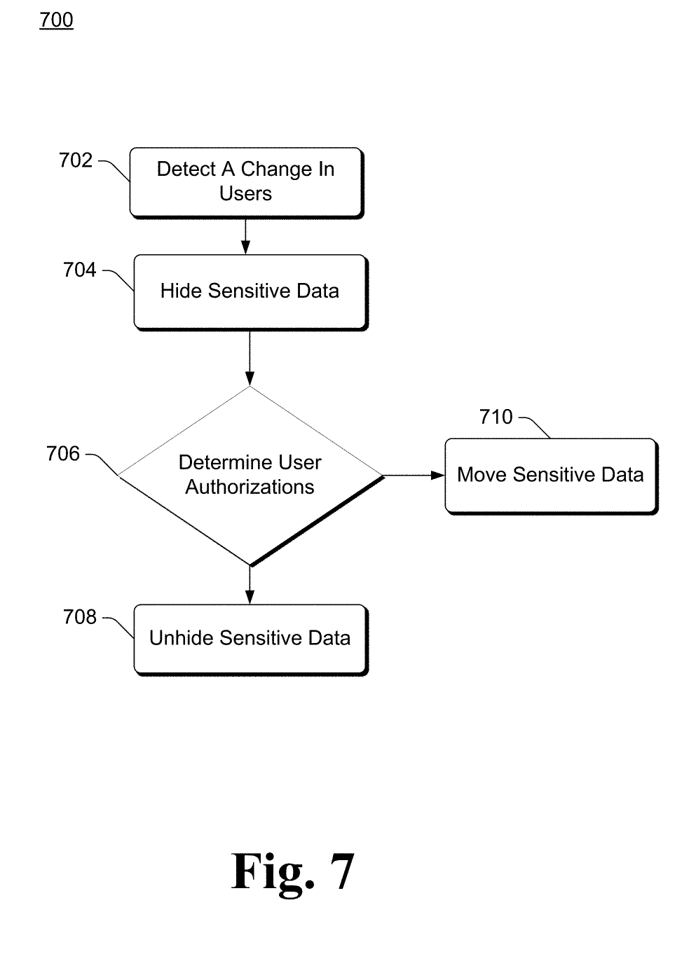

FIG. 7 is a flowchart illustrating an example process 700 for personalizing meetings in accordance with one or more embodiments. Process 700 is an example process and can alternately comprise fewer or additional elements.

In act 702 a change in the users is detected. The change may comprise detecting an additional user for instance, by recognizing a new user device has entered a space, a username and password being input, motion detection or video or image recognition of a person in a vicinity of the host system, such as entering a room in which the host system is located, coming within a threshold distance (e.g. 15 feet) of the host system, approaching the host system (e.g. walking toward the host system rather than laterally along the host system). Alternately, a field of view can be defined for the display device, and a change in the users can be detected if the additional person enters the field of view. For instance, the field of view can be defined as an angle and a distance from a camera of the host system (for instance 180 degrees and 15 feet). The field of view can vary based on display size of information at the host system 102, security measures such as screen tint, features of the room (such as pillars, doorways, and windows).

Alternately, the change in users may comprise detecting one or more of the users leaving the meeting. Similar to detecting an additional user, detecting that a user is leaving may be accomplished using a variety of techniques including motion detection, video or image recognition, loss of connectivity to a user device, manually signing out, or any other desired means.

In act 704, sensitive data is hidden. Hiding sensitive data may comprise obscuring the data, such as by blacking out or blurring the sensitive data, closing or minimizing an application containing sensitive data, or otherwise removing the sensitive data from the screen. Alternately, if an unauthenticated user is wearing a head mounted display, the sensitive data could be obscured at the head mounted display rather than at the display of the host system 102.

In act 706, user authorizations are determined. This determining comprises authenticating the users by any of the means described above, determining the permissions associated with the users, and determining if the permissions associated with the users allow read/write, read, or no access to the hidden sensitive data. This determining may include reauthorizing all users present, alternately, only a new user needs to be authorized.

Further, determining the user authorizations includes determining if a change in permissions has occurred. For instance, it may be determined that a user who was authorized to share a file has left, and that no remaining user has permission to share the file.

It may be determined that there are no remaining users who are authorized to use the container. Accordingly, the container, and any changes made to the container, may be saved and closed for later use by authorized users. Alternately, the files and programs in the container may be saved and closed and the container discarded.

If the users are determined to have permission to view the content, the sensitive data is unhidden in act 708.

If the user authorizations are determined to be different from the original authorizations, the sensitive data is moved according to the new user authorization in act 710. The new group of users may be authorized to view a different subset of the sensitive data than the original group. For instance, the new group may be authorized to view more sensitive data at the host system 102 because a user who was not authorized to view the sensitive data has left, or a new user has arrived who is authorized to share the sensitive data. Alternately, the new group may be authorized to view less sensitive data at the host system 102 because a new user does not have permission to view the sensitive data, or because a user who had permission to share the data has left.

Moving the sensitive data may comprise moving the sensitive data to secondary displays associated with users who have permission to view the content when at least one user is determined not to have permission to view the data. For instance, if the users are wearing a head mounted device, the sensitive data can be displayed for the users who are authorized to view the content such that it appears to be part of the host system 102 display. Alternately, the sensitive data can be displayed at the users' tablet, phone, laptop, or other personal device. In some embodiments, when the sensitive data is moved, the data may be marked to notify the authorized users to avoid unintentional verbal disclosure. When there is a change of users detected such as at 702, the credential checking module 130 may trigger certain actions or notifications to both the host system 102 and the user devices 118. In response to the trigger, the host system 102 and the user devices 118 update their display, ensuring the right data is available to the users with the appropriate access level. In some embodiments, the trigger has the ability to disable the display at the host system 102 to prevent unintended access. In some embodiments there may be more than two simultaneous access levels present.

Alternately, if the sensitive data is associated with a user who has left, the data may be saved to a user specific layer and the user specific layer may be closed.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

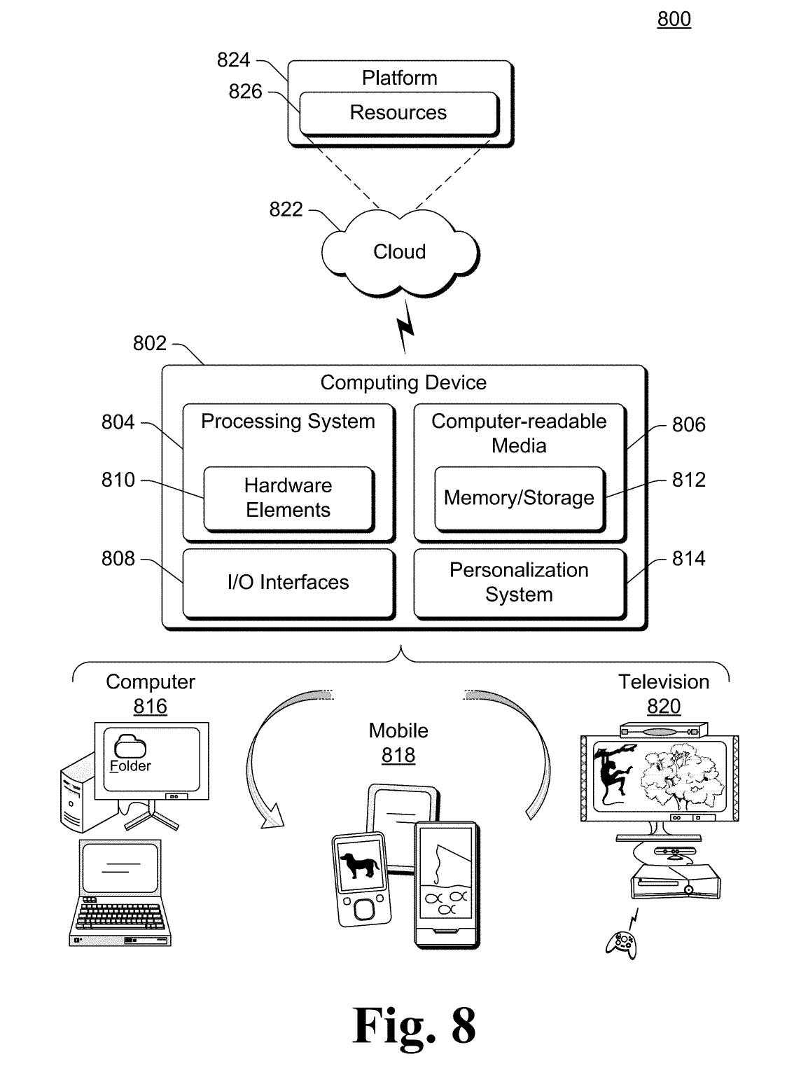

FIG. 8 illustrates an example system generally at 800 that includes an example computing device 802 that is representative of one or more systems and/or devices that may implement the various techniques described herein. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

The one or more input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

The computing device 802 also includes a personalization system 814. The personalization system 814 provides various functionality supporting personalizing meetings as discussed herein. The personalization system 814 can implement, for example, the host system 102, container system 104, container store 106, and/or layer repository 110 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules as a module that is executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 802 may assume a variety of different configurations, such as for computer 816, mobile 818, and television 820 uses. Each of these configurations includes devices that may have generally different constructs and capabilities, and thus the computing device 802 may be configured according to one or more of the different device classes. For instance, the computing device 802 may be implemented as the computer 816 class of a device that includes a personal computer, desktop computer, a multi-screen computer, laptop computer, netbook, and so on.

The computing device 802 may also be implemented as the mobile 818 class of device that includes mobile devices, such as a mobile phone, portable music player, portable gaming device, a tablet computer, a virtual reality headset, an augmented reality headset, a multi-screen computer, and so on. The computing device 802 may also be implemented as the television 820 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This functionality may also be implemented all or in part through use of a distributed system, such as over a “cloud” 822 via a platform 824 as described below.

The cloud 822 includes and/or is representative of a platform 824 for resources 826. The platform 824 abstracts underlying functionality of hardware (e.g., servers) and software resources of the cloud 822. The resources 826 may include applications and/or data that can be utilized while computer processing is executed on servers that are remote from the computing device 802. Resources 826 can also include services provided over the Internet and/or through a subscriber network, such as a cellular or Wi-Fi network.

The platform 824 may abstract resources and functions to connect the computing device 802 with other computing devices. The platform 824 may also serve to abstract scaling of resources to provide a corresponding level of scale to encountered demand for the resources 826 that are implemented via the platform 824. Accordingly, in an interconnected device embodiment, implementation of functionality described herein may be distributed throughout the system 800. For example, the functionality may be implemented in part on the computing device 802 as well as via the platform 824 that abstracts the functionality of the cloud 822.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: authenticating a user at a host system; determining, from a profile associated with the user, one or more preferences or permissions of the user; creating a container, comprising an isolated computing space, based in part on the determined preferences or permissions; and providing the container for use at the host system.

Alternatively or in addition to any of the methods or devices described herein, any one or combination of: the creating the container further comprising creating the container based on a time of day; the creating the container further comprising creating the container based on a profile of the host system; the method further comprising detecting a program or file accessed by the user, and changing the container based on the accessed program or file; the method further comprising tracking changes made to the container by the user, associating the tracked changes with the profile associated with the user, and changing one or more of the preferences in the profile associated with the user based on the tracked changes; the method further comprising tracking changes made to the container at the host system, associating the tracked changes with a profile of the host system, and changing a layer provided to the host system based on the tracked changes; the method further comprising saving containers and/or layers including one or more changes for later use; the authenticating the user comprising one or more of: facial recognition, username and password entry, biometric scanning, and near-field communication.

A method comprising: authenticating multiple users at a host system; receiving a request to access sensitive data, the sensitive data associated with one or more permissions; determining if each of the multiple users is authorized to access the sensitive data based on the one or more permissions; displaying a first set of sensitive data at a display device of the host system, each of the multiple users authorized to view the first set of sensitive data; and not displaying a second set of sensitive data at the display device of the host system, at least one of the multiple users not authorized to view the second set of sensitive data.

Alternatively or in addition to any of the methods or devices described herein, any one or combination of: the method further comprising detecting an additional user, hiding one or more pieces of the sensitive data, authenticating the additional user, determining the additional user is authorized to view the one or more pieces of sensitive data, and unhiding the one or more pieces of sensitive data; the method further comprising detecting an additional user, hiding one or more pieces of sensitive data, authenticating the additional user, determining the additional user is not authorized to view the one or more pieces of sensitive data, and sending the one or more pieces of sensitive data to a user device; the sending allowing the user device to notify a user that the one or more pieces of sensitive data are sensitive responsive to the user focusing on one of the one or more pieces of sensitive data; the method further comprising detecting a user of the multiple users leaving, and removing from the display device one or more pieces of data associated with the user; the method further comprising detecting a user of the multiple users leaving, and displaying the second set of sensitive data responsive to determining the remaining users are authorized to view the second set of sensitive data; the method further comprising consolidating the permissions from the sensitive data at the host system.

A computing device comprising: a processor; a display device; and a computer-readable storage media having stored thereon multiple instructions that, when executed by the processor, cause the processor to: authenticate multiple users, each of the multiple users associated with a different one of multiple user profiles; create a container, based in part on the user profiles, comprising an isolated computing space containing one or more programs and files; determine the one or more programs and files include sensitive data, the sensitive data associated with one or more permissions; determine if the multiple users are authorized to access the sensitive data; and display a subset of the sensitive data at the computing device, the subset comprising the sensitive data that each of the multiple users is authorized to access.

Alternatively or in addition to any of the methods or computing devices described herein, any one or combination of: the multiple instructions further causing the processor to detect a user of the multiple users leaving, and remove from the display device one or more pieces of data associated with the user; the multiple instructions further causing the processor to detect one of the multiple users leaving, and move one or more pieces of data to the display device responsive to the remaining users having access to the piece of data; the multiple instructions further causing the processor to track one or more changes made to the container by a user of the multiple users, associate the one or more changes with the user, and learn one or more user preferences based on the changes; the multiple instructions further causing the processor to track one or more changes made to the container at the host system, associate the one or more changes with a profile of the host system, and learn one or more preferences of users at the host system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
authenticating a user at a host system;
determining, from a profile associated with the user, one or more preferences or permissions of the user;
creating a container, comprising an isolated computing space, based in part on the determined preferences or permissions; and
providing the container for use at the host system.

2. A method as recited in claim 1, the creating the container further comprising creating the container based on a time of day.

3. A method as recited in claim 1, the creating the container further comprising creating the container based on a profile of the host system.

4. A method as recited in claim 1, further comprising detecting a program or file accessed by the user, and changing the container based on the accessed program or file.

5. A method as recited in claim 1, further comprising:
tracking changes made to the container by the user;
associating the tracked changes with the profile associated with the user; and
changing one or more of the preferences in the profile associated with the user based on the tracked changes.

6. A method as recited in claim 1, further comprising:
tracking changes made to the container at the host system;
associating the tracked changes with a profile of the host system; and
changing a layer provided to the host system based on the tracked changes.

7. A method as recited in claim 1, further comprising saving containers and/or layers including one or more changes for later use.

8. A method as recited in claim 1, the authenticating the user comprising one or more of: facial recognition, username and password entry, biometric scanning, and near-field communication.

9. A method comprising:
authenticating multiple users at a host system;
receiving a request to access sensitive data, the sensitive data associated with one or more permissions;
determining if each of the multiple users is authorized to access the sensitive data based on the one or more permissions;
displaying a first set of sensitive data at a display device of the host system, each of the multiple users authorized to view the first set of sensitive data; and
not displaying a second set of sensitive data at the display device of the host system, at least one of the multiple users not authorized to view the second set of sensitive data.

10. A method as recited in claim 9, further comprising:
detecting an additional user;
hiding one or more pieces of the sensitive data;
authenticating the additional user;
determining the additional user is authorized to view the one or more pieces of sensitive data; and
unhiding the one or more pieces of sensitive data.

11. A method as recited in claim 9, further comprising:
detecting an additional user;
hiding one or more pieces of sensitive data;
authenticating the additional user;
determining the additional user is not authorized to view the one or more pieces of sensitive data; and
sending the one or more pieces of sensitive data to a user device.

12. A method as recited in claim 11, the sending allowing the user device to notify a user that the one or more pieces of sensitive data are sensitive responsive to the user focusing on one of the one or more pieces of sensitive data.

13. A method as recited in claim 9, further comprising:
detecting a user of the multiple users leaving; and
removing from the display device one or more pieces of data associated with the user.

14. A method as recited in claim 9, further comprising:
detecting a user of the multiple users leaving; and
displaying the second set of sensitive data responsive to determining the remaining users are authorized to view the second set of sensitive data.

15. A method as recited in claim 9, further comprising consolidating the permissions from the sensitive data at the host system.

16. A computing device comprising:
a processor;
a display device; and
a computer-readable storage media having stored thereon multiple instructions that, when executed by the processor, cause the processor to:
authenticate multiple users, each of the multiple users associated with a different one of multiple user profiles;
create a container, based in part on the user profiles, comprising an isolated computing space containing one or more programs and files;
determine the one or more programs and files include sensitive data, the sensitive data associated with one or more permissions;
determine if the multiple users are authorized to access the sensitive data; and
display a subset of the sensitive data at the computing device, the subset comprising the sensitive data that each of the multiple users is authorized to access.

17. A computing device as recited in claim 16, the multiple instructions further causing the processor to:
detect a user of the multiple users leaving; and
remove from the display device one or more pieces of data associated with the user.

18. A computing device as recited in claim 16, the multiple instructions further causing the processor to:
detect one of the multiple users leaving; and
move one or more pieces of data to the display device responsive to the remaining users having access to the piece of data.

19. A computing device as recited in claim 16, the multiple instructions further causing the processor to:
track one or more changes made to the container by a user of the multiple users;
associate the one or more changes with the user; and
learn one or more user preferences based on the changes.

20. A computing device as recited in claim 16, the multiple instructions further causing the processor to:
track one or more changes made to the container at the host system;
associate the one or more changes with a profile of the host system; and
learn one or more preferences of users at the host system.
